(19) United States
(12) Patent Application Publication
(10) Pub. No.: US 2019/0091886 A1
(43) Pub. Date: Mar. 28, 2019

(54) METHOD FOR CUTTING ADHESIVE FILM, ADHESIVE FILM, AND WOUND BODY

(71) Applicant: DEXERIALS CORPORATION, Tokyo (JP)

(72) Inventors: Kazuhide HORIKAWA, Tokyo (JP); Yoko SATO, Tokyo (JP)

(73) Assignee: DEXERIALS CORPORATION, Tokyo (JP)

(21) Appl. No.: 16/082,626

(22) PCT Filed: Mar. 27, 2017
(86) PCT No.: PCT/JP2017/012409

§ 371 Date: Sep. 6, 2018

(30) Foreign Application Priority Data
Mar. 31, 2016 (JP) 2016-073090

(51) Int. Cl. B26D 7/08; B65H 18/28; B65H 35/00; C09J 9/02; C09J 7/25

(52) U.S. Cl. CPC B26D 7/08; B26D 7/086; C09J 7/255; B65H 35/008; C09J 9/02; B65H 18/28

(57) ABSTRACT

There is provided a method for cutting an adhesive film and an adhesive film that are novel and improved and capable of fabricating an adhesive film with a low glass transition point, high quality, and a width of less than 1 mm. According to an aspect of the present invention in order to achieve the above object, there is provided a method for cutting an adhesive film, the method including cutting, under a temperature environment of −40 to 10° C., an adhesive film that satisfies a condition of the following formula (1) and whose tack value per unit length under room temperature is 3N/cm or more.

y≤−0.27x+11.4 (1)

In the formula (1), x is a glass transition point (° C.) of the adhesive film, and y is a tack value per unit length (N/cm) under room temperature of the adhesive film.

### TECHNICAL FIELD

The present invention relates to a method for cutting an adhesive film, an adhesive film, and a wound body.

### BACKGROUND ART

Patent Literature 1 discloses a technology of slitting an adhesive film. In this technology, the adhesive film is slit in a state in which the adhesive film is heated beforehand. The cut adhesive film is used for various purposes, such as adhesion between electronic components. Incidentally, as electronic components have become smaller, for example, needs for narrowing widths of adhesive films have become very strong. For example, an anisotropic conductive film, which is an example of an adhesive film, is used for adhesion between constituent elements arranged within an outer frame (so-called bezel) of various displays in some cases. There are a variety of displays in which an anisotropic conductive film is used. For example, an anisotropic conductive film is used for, as well as various stationary displays, a portable display (for example, a display for a smartphone, a mobile phone, and a wearable device, etc.). Outer frames of these displays have been narrowed year by year mainly for an increase in the proportion of a display area. Therefore, needs for narrowing widths of adhesive films, particularly anisotropic conductive films, have become very strong.

### CITATION LIST

### Patent Literature

Patent Literature 1: JP 2005-288641A

Patent Literature 2: JP 2003-71783A

Patent Literature 3: JP 2014-108471A

### SUMMARY OF INVENTION

### Technical Problem

However, in the case where the adhesive film is cut into a width of less than 1 mm by using the technology disclosed in Patent Literature 1, lifetime of the adhesive film after adhesion may decrease. A possible reason for this is that at least part of the adhesive film is caused to deteriorate by heating. That is, in the case where the adhesive film has a large width, it is likely that its partial deterioration does not greatly influence lifetime, because the volume of the adhesive film itself is large. However, in an adhesive film with a width of less than 1 mm, deterioration has relatively large influence, because the volume of the adhesive film is very small. As a result, lifetime of the adhesive film may decrease. Furthermore, since rigidity of the adhesive film is caused to decrease by heating, there is a possibility that shearing force does not sufficiently act on the adhesive film when the adhesive film is tried to be cut into a width of less than 1 mm. Therefore, cutting precision may become worse. Furthermore, simply cutting the adhesive film into a thin width may cause a decrease in adhesive power of the cut adhesive film, because in regard to an adhesive film with a thin width, the volume of the adhesive film itself is small. In the case where adhesive power of the adhesive film decreases, a problem in that connection strength of a joint using the adhesive film decreases may occur.

Therefore, the technology disclosed in Patent Literature 1 has a problem in that quality of the cut adhesive film decreases in the case where the adhesive film is cut into a width of less than 1 mm.

Note that a possible method for solving the problem related to adhesive power of the adhesive film is to increase adhesive power per unit area of the adhesive film. However, simply increasing adhesive power per unit area of the adhesive film may, on the contrary, cause a decrease in quality of the adhesive film. For example, blocking may occur in the case where a wound body is fabricated using the adhesive film. Here, blocking means that the adhesive film in the wound body sticks to another adhesive film etc. Blocking of the adhesive film causes poor pull-out, a loss of the adhesive film, etc. In addition, in the case where such a highly-adhesive adhesive film is tried to be cut by using the technology disclosed in Patent Literature 1, the adhesive film may attach to a cutting blade.

Furthermore, in the field of anisotropic conductive films, curing at low temperature and in short time has been strongly required in recent years. Therefore, a further decrease in glass transition point of an adhesive film has been strongly required. However, in the case where the glass transition point of the adhesive film decreases, adhesive power per unit area of the adhesive film tends to increase. Therefore, simply lowering the glass transition point of the adhesive film may cause the above-described problem related to adhesive power of the adhesive film.

On the other hand, Patent Literatures 2 and 3 disclose technologies of cutting a material other than an adhesive film. Patent Literature 2 discloses a technology of cutting a cellulose triacetate film. In this technology, a portion to be cut of the cellulose triacetate film is heated in advance to a temperature of equal to or greater than 60° C. and less than a glass transition point, and then the film is cut. Therefore, in the case where the technology disclosed in Patent Literature 2 is applied to cutting of an adhesive film, a problem similar to that in Patent Literature 1 may occur.

Patent Literature 3 proposes a technology of cutting a wafer including silicon or the like. In this technology, a technology of cutting the wafer while cooling and applying ultrasonic vibration to a diamond blade is disclosed. However, since this technology cuts a wafer, which is completely different from an adhesive film, it cannot be applied to cutting of an adhesive film. Furthermore, even if this technology can be applied to cutting of an adhesive film, the problem of adhesive power of the adhesive film cannot be solved at all.

Therefore, the technologies disclosed in Patent Literatures 1 to 3 cannot fabricate an adhesive film with a low glass transition point, high quality, and a width of less than 1 mm.

Hence, in view of the above problems, an object of the present invention is to provide a method for cutting an adhesive film, an adhesive film, and a wound body that are novel and improved and capable of fabricating an adhesive film with a low glass transition point, high quality, and a width of less than 1 mm.

### Solution to Problem

According to an aspect of the present invention in order to achieve the above object, there is provided a method for cutting an adhesive film, the method including cutting, under a temperature environment of −40 to 10° C., an adhesive film that satisfies a condition of the following formula (1) and whose tack value per unit area under room temperature is 3N/cm or more.

y=−0.27x+11.4 (1)

In the formula (1), x is a glass transition point (° C.) of the adhesive film, and y is a tack value per unit area (N/cm) under room temperature of the adhesive film.

According to this aspect, under a temperature environment of −40 to 10° C., an adhesive film that satisfies a condition of the following formula (1) and whose tack value per unit area under room temperature is 3N/cm or more is cut. Therefore, deterioration of the adhesive film is suppressed. Furthermore, rigidity of the adhesive film is ensured, which improves cutting precision. Furthermore, attachment of the adhesive film to a cutting blade is suppressed; also in this point, cutting precision is improved. Therefore, according to this cutting method, the cut adhesive film can have high quality even if the adhesive film is cut into a width of less than 1 mm. Furthermore, the glass transition point of the adhesive film is very low. Therefore, according to this aspect, an adhesive film with a low glass transition point, high quality, and a width of less than 1 mm can be fabricated.

Here, the tack value of the adhesive film may be 10N/cm or less.

In addition, the adhesive film may be cut into a width of less than 1 mm.

In addition, the adhesive film may be cut while a cutting blade that cuts the adhesive film is cooled.

In addition, the adhesive film may be cut while ultrasonic vibration is applied to a cutting blade that cuts the adhesive film.

According to another aspect of the present invention, there is provided an adhesive film that satisfies a condition of the following formula (1) and has a tack value under room temperature of 3N/cm or more and a width of less than 1 mm.

y=−0.27x+11.4 (1)

In the formula (1), x is a glass transition point (° C.) of the adhesive film, and y is a tack value (N/cm) of the adhesive film.

Here, the adhesive film may contain conductive particles.

According to another aspect of the present invention, there is provided a wound body including the above adhesive film.

### Advantageous Effects of Invention

According to the present invention as described above, therefore, according to this aspect, an adhesive film with a low glass transition point, high quality, and a width of less than 1 mm can be fabricated.

### BRIEF DESCRIPTION OF DRAWINGS

FIG. 1 is a graph for describing requirements satisfied by an adhesive film according to an embodiment of the present invention.

FIG. 2 is a side cross-sectional view of an example of a thin-width film.

FIG. 3A is a side view of an example of a wound body.

FIG. 3B is a front view of an example of a wound body.

### DESCRIPTION OF EMBODIMENTS

Hereinafter, (a) preferred embodiment(s) of the present invention will be described in detail with reference to the appended drawings. Note that, in this specification and the appended drawings, structural elements that have substantially the same function and structure are denoted with the same reference numerals, and repeated explanation of these structural elements is omitted.

### <1. Studies by Present Inventors>

As a result of extensive studies on a technology for solving the above-described problems, the present inventors have devised a method for cutting an adhesive film according to the present embodiment. Hence, first, the studies made by the present inventors are described.

The present inventors first made extensive studies on a cutting method that solves the problems of the technology disclosed in Patent Literature 1. Consequently, the present inventors devised cutting an adhesive film into a thin width while cooling the adhesive film. Specifically, the present inventors devised cutting the adhesive film under a temperature environment of −40 to 10° C. This technology suppresses deterioration of the adhesive film, because the adhesive film is placed under a temperature environment of −40 to 10° C. Furthermore, rigidity of the adhesive film is ensured, which improves cutting precision. Furthermore, even if adhesive power per unit area of the adhesive film is high, the adhesive film is less likely to attach to a cutting blade. Also in this point, cutting precision is improved.

Next, the present inventors made a study on adhesive power and a glass transition point (Tg) of the cut adhesive film for the following reasons. As described above, simply cutting the adhesive film into a thin width may cause a decrease in adhesive power of the cut adhesive film. In addition, although adhesive power tends to increase as the glass transition point decreases, too high adhesive power, on the contrary, causes a decrease in quality of the adhesive film.

Specifically, the present inventors prepared various adhesive films with glass transition points of 40° C. or less. Here, glass transition points were set to 40° C. or less because, as described above, a glass transition point of an adhesive film has been required to be lowered. Then, these adhesive films were cut into a width of less than 1 mm by the cutting method described above, and quality of the cut adhesive films was evaluated. Slitting property (cutting ease), blocking resistance (resistance to blocking), peel strength, etc. of the adhesive films were evaluated (details are described later). Here, good or bad of slitting property is evaluated by, for example, attachment of the adhesive film to a cutting blade. As the amount of the adhesive film attached to the cutting blade is smaller, a more favorable cut surface is obtained, resulting in more favorable slitting property.

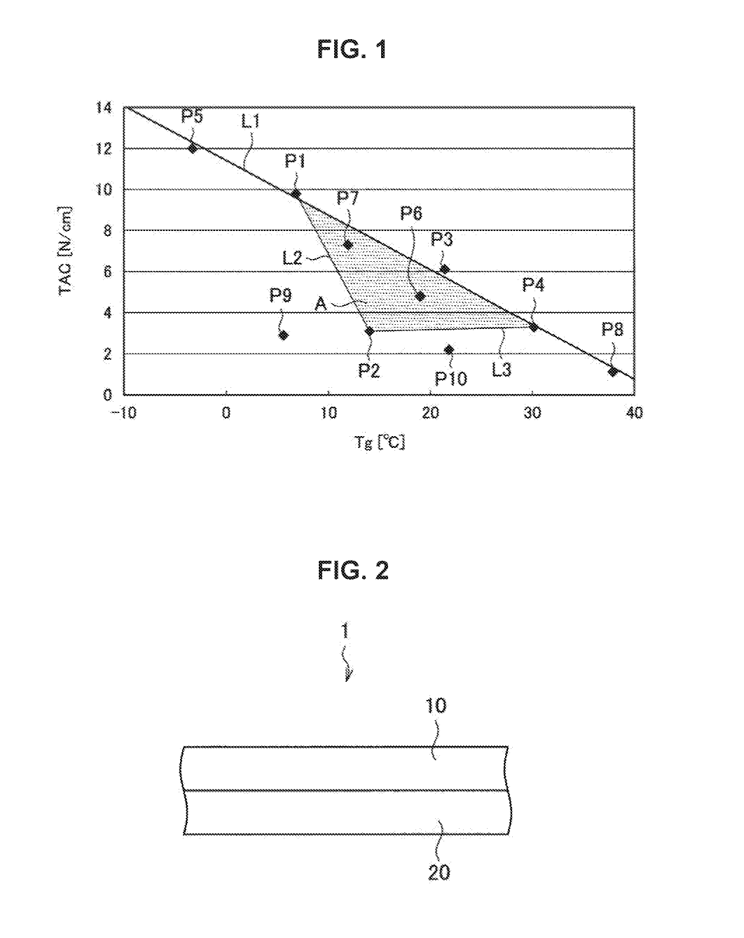

FIG. 1 shows the results. In FIG. 1, the horizontal axis (x axis) represents a glass transition point (° C.) of an adhesive film, and the vertical axis (y axis) represents a tack value (N/cm) of an adhesive film. That is, the present inventors focused on a tack value (TAC) as an index indicating adhesive power of an adhesive film. A tack value can be measured by a commercially available tack tester. Unless otherwise specified, a tack value in the present embodiment is a value per unit length of an adhesive film with a width of 1 cm, and is a value measured under room temperature.

Points P1 to P10 indicate glass transition points and tack values of the adhesive films studied by the present inventors. The adhesive films indicated by the points P1 to P7 were evaluated to be favorable. Furthermore, distribution of the points P1 and P3 to P5 exhibited linear regularity. Hence, the present inventors calculated an approximation straight line L1 of the points P1 and P3 to P5 by a method of least squares. The approximation straight line L1 is represented by the following formula (1). In addition, the points P1 and P3 to P5 are regarded as points on the straight line L1.

y=−0.27x+11.4 (1)

In the formula (1), x is a glass transition point (° C.) of the adhesive film, and y is a tack value (N/cm) of the adhesive film.

As mentioned above, in regard to the points P1 and P3 to P5 on the straight line L1, the adhesive films were evaluated to be favorable. Furthermore, also in regard to the points P2 and P6 to P7 present below the straight line L1, the adhesive films were evaluated to be favorable. Furthermore, a point present above the straight line L1 is estimated to exhibit too large a tack value. According to these matters, the present inventors found that, as a requirement to be satisfied by an adhesive film, a glass transition point and a tack value need to be present in a region below the straight line L1.

Furthermore, the tack value indicated by the point P2 is approximately 3N/cm. In regard to the point P8 present in a region below the point P2, peel strength of the adhesive film was lower. This means that the tack value of the point P8 is too small. In the case where an adhesive film with too small a tack value is used for adhesion between a plurality of electronic components etc., connection strength of a joint may be small. In addition, in regard to the points P9 and P10 present in a region below the point P2, a practical problem occurred when the adhesive film was cut under a cutting temperature of −40° C. Therefore, the present inventors found that, as a requirement to be satisfied by an adhesive film, a tack value of the adhesive film needs to be 3N/cm or more. The above matters are summarized as follows: an adhesive film needs to satisfy the following conditions 1 and 2.

(Condition 1) A glass transition point and a tack value of the adhesive film satisfy a condition of the following formula (1).

y=−0.27x+11.4 (1)

(Condition 2) A tack value under room temperature of the adhesive film is 3N/cm or more.

In regard to an adhesive film satisfying the conditions 1 and 2, slitting property, blocking resistance, and peel strength of the adhesive film are all favorable. Therefore, quality of the adhesive film is improved. In addition, a glass transition point of the adhesive film satisfying the conditions 1 and 2 is about 31° C. or less; thus, the glass transition point is low.

In addition, the present inventors made a further study on the tack value, and found that the tack value is preferably 10 (N/cm) or less. In this case, characteristics of the adhesive film, specifically slitting property and blocking resistance, are improved.

In addition, since the evaluation results of the points P1 to P4, P6, and P7 were the most favorable, the present inventors found that characteristics of adhesive films are the most favorable in a region A surrounded by straight lines L1 to L3. Here, the straight line L2 is a straight line connecting the point P1 and the point P2, and the straight line L3 is a straight line connecting the point P2 and the point P4.

On the basis of the above findings, the present inventors have devised the method for cutting an adhesive film according to the present embodiment. This cutting method makes it possible to fabricate an adhesive film with a low glass transition point, high quality, and a width of less than 1 mm. The present embodiment is described below.

### <2. Adhesive Film>

Next, an adhesive film to be cut in the present embodiment is described. As mentioned above, the adhesive film satisfies the following conditions 1 and 2.

(Condition 1) A glass transition point and a tack value under room temperature of the adhesive film satisfy a condition of the following formula (1).

y=−0.27x+11.4 (1)

In the formula (1), x is a glass transition point (° C.) of the adhesive film, and y is a tack value (N/cm) under room temperature of the adhesive film.

(Condition 2) A tack value under room temperature of the adhesive film is 3N/cm or more.

Here, a tack value can be measured by a commercially available tack tester. In addition, the tack value is preferably 10N/cm or less. In the case where the tack value is 10N/cm or less under room temperature, blocking of the adhesive film is further less likely to occur, and slitting property is further favorable. In addition, in the case where the adhesive film is formed on a base material film, the adhesive film is easily peeled off from the base material film. Furthermore, a glass transition point and a tack value of the adhesive film are further preferably values in the region A illustrated in FIG. 1. In this case, slitting property, blocking resistance, and peel strength of the adhesive film are further favorable. In the case where the condition 2 is not satisfied, a problem occurs as follows: peel strength of the adhesive film decreases, the adhesive film cannot be cut, or a practical problem occurs in a shape after the cutting. Here, as examples of the practical problem, the adhesive film is greatly peeled from the base material film (for example, in the case where the adhesive film is used as a wound body, peeling of one round or more of a reel occurs), a cut surface is rough, a large wrinkle occurs in the cut adhesive film, etc.

In addition, in the case where the adhesive film is used as an anisotropic conductive film, satisfying the above conditions 1 and 2 improves electrical characteristics as the anisotropic conductive film, specifically connection resistance.

A specific composition of the adhesive film is not particularly limited, and any composition can be suitably used in the present embodiment as long as it is used as an adhesive film. As an example, the adhesive film may contain a film-forming resin, a polymerizable compound, and a curing initiator. In the case where the adhesive film serves as an anisotropic conductive film, the adhesive film may further contain conductive particles.

The film-forming resin is a material that keeps the adhesive film in a film form. Examples of the film-forming resin include various resins such as an epoxy resin, a phenoxy resin, a polyester-urethane resin, a polyester resin, a polyurethane resin, an acrylic resin, a polyimide resin, and a butyral resin. In the present embodiment, only one type of these film-forming resins can be used, or two or more types can be freely combined to be used. Note that the film-forming resin is preferably a phenoxy resin in terms of making film formability and adhesion reliability favorable.

The polymerizable compound is a resin that is cured by mutual polymerization. Examples of the polymerizable compound include an epoxy polymerizable compound and an acrylic polymerizable compound. The epoxy polymerizable compound is a monomer, an oligomer, or a prepolymer having one or two or more epoxy groups in a molecule. Examples of the epoxy polymerizable compound include various bisphenol-type epoxy resins (bisphenol A-type, F-type, etc.), a novolac-type epoxy resin, various modified epoxy resins such as rubber and urethane, a naphthalene-type epoxy resin, a biphenyl-type epoxy resin, a phenol novolac-type epoxy resin, a stilbene-type epoxy resin, a tri-phenol-methane-type epoxy resin, a dicyclopentadiene-type epoxy resin, a triphenylmethane-type epoxy resin, and prepolymers of these. In the present embodiment, one type of the polymerizable compounds given above may be used, or two or more types may be freely combined to be used.

The curing initiator is a material that starts polymerization (i.e., curing) of the polymerizable compound. Examples of the curing initiator include a thermosetting initiator and a photocuring initiator. The thermosetting initiator is a material that is activated by absorbing heat to start polymerization of the polymerizable compound. Examples of the thermosetting initiator include a thermal anionic or thermal cationic curing initiator that cures an epoxy polymerizable compound, and a thermal radical curing initiator that cures an acrylic polymerizable compound. In the present embodiment, an appropriate thermosetting initiator may be selected depending on the polymerizable compound.

The photocuring initiator is a material that is activated by light (e.g., UV light) to start polymerization of the polymerizable compound. A type of the photocuring initiator is not particularly limited, and examples include a photo-cationic curing initiator and a photo-radical curing initiator.

The conductive particles are particles for anisotropic conductive connection between a plurality of terminals. A type of the conductive particles is not particularly limited. Examples of the conductive particles include metal particles, and metal-coated resin particles. Examples of the metal particles include metal particles of nickel, cobalt, copper, silver, gold, palladium, or the like. Examples of the metal-coated resin particles include particles obtained by covering the surface of core resin particles of a styrene-divinylbenzene copolymer, a benzoguanamine resin, a crosslinked polystyrene resin, an acrylic resin, a styrene-silica composite resin, or the like with a metal such as nickel, copper, gold, or palladium. On the surface of the conductive particles may be formed a gold or palladium thin film, an insulating resin thin film that is thin enough to be broken at the time of crimping, or the like. Note that an anisotropic conductive material may include two or more types of conductive particles.

In addition, the adhesive film may contain various additives etc. as well as the above components. Examples of such an additive include a silane coupling agent, an inorganic filler, a coloring agent, an oxidation inhibitor, and an anticorrosive.

In addition, the adhesive film may be formed on a base material film. The adhesive film may be formed on the base material film with a parting agent therebetween. This enables the adhesive film to be easily peeled off from the base material film. For example, even if the tack value of the adhesive film is larger than 10N/cm, the adhesive film is easily peeled off from the adhesive film. In addition, the adhesive film may be covered with a protective film. The base material film and the protective film are peeled off when the adhesive film is used.

In addition, the adhesive film may have a multilayer structure. For example, a lower layer of the adhesive film may be a layer containing conductive particles (so-called A layer), and an upper layer of the adhesive film may be a layer not containing conductive particles (so-called N layer). Note that a tack value and a glass transition point when the adhesive film has a multilayer structure substantially match a tack value and a glass transition point of a single-layer adhesive film that includes the same components as materials of the layers and in which a blending ratio (e.g., parts by mass) of the components is a total value of blending ratios of the layers.

### <3. Method for Cutting Adhesive Film>

Next, a method for cutting an adhesive film is described. In the present embodiment, the adhesive film is cut under a cutting temperature environment of −40 to 10° C. Therefore, deterioration of the adhesive film can be suppressed. Furthermore, rigidity of the adhesive film can be ensured, which improves cutting precision. Furthermore, the adhesive film can be cut while attachment of the adhesive film is suppressed. Also in this point, cutting precision is improved. In the case where cutting temperature exceeds 10° C., a problem similar to that in Patent Literature 1 may occur. On the other hand, in the case where cutting temperature is less than −40° C., the adhesive film gets too hard, which may cause a problem (e.g., the adhesive film is broken during cutting or during winding). A preferable upper limit value of the cutting temperature is 0° C. or less. Thus, moisture in the air freezes, which suppresses condensation on the adhesive film.

Therefore, according to this cutting method, an adhesive film with a low glass transition point, high quality, and a width of less than 1 mm can be fabricated.

Note that the adhesive film may be subjected to precooling before cutting. Specifically, the adhesive film may be exposed to a temperature environment of approximately −5 to 15° C. before being exposed to a temperature environment of −40 to 10° C. Thus, the adhesive film can be cooled more reliably. A preferable upper limit value of precooling temperature is 0° C. or less. This suppresses condensation on the adhesive film at the time of precooling.

Although a cutting width of the adhesive film may be decided in accordance with the purpose of the cut adhesive film, in the present embodiment, the cutting width can be less than 1 mm. The cutting width is preferably 0.8 mm or less, further preferably 0.6 mm or less, further preferably 0.5 mm or less, further preferably less than 0.5 mm. A lower limit value of the cutting width is not particularly limited, but may be 0.3 mm or more, for example. Therefore, an example of a preferable range of the cutting width is equal to or greater than 0.3 mm and less than 1 mm.

A type of a cutting device that cuts the adhesive film is not particularly limited, as long as the cutting device can cut the adhesive film into the above cutting width. For example, a cutting device disclosed in the specification of JP Patent No. 4123804, or the like can be used. In cutting, a cutting blade may be cooled separately. For example, cold air or the like may be applied to the cutting blade. Furthermore, in cutting, ultrasonic vibration may be applied to the cutting blade. This further improves cutting precision. A vibration frequency is not particularly limited, but may be 16 to 30 kHz, for example.

A method for achieving the above temperature environment is not particularly limited, but the following method can be given as an example. First, the temperature of a workroom where cutting of the adhesive film is performed is set to the precooling temperature mentioned above. Temperature setting may be performed by air conditioning of the workroom. In addition, the interior of the workroom is preferably subjected to dehumidification in order to suppress condensation on the adhesive film. Furthermore, a booth is set around the cutting device, and temperature in the booth is set to the cutting temperature mentioned above. Temperature adjustment in the booth may be performed by, for example, introducing cold air into the booth.

The cut adhesive film (hereinafter, such an adhesive film will also be referred to as “thin-width film”) is made into a wound body by, for example, being wound around an empty reel. Note that in the case where the adhesive film is cut at 0° C. or less, the thin-width film is unfrozen at any timing. Unfreezing may be performed before winding around the empty reel, or may be performed after winding. However, in the case where the thin-width film in a frozen state is wound around the empty reel, the thin-width film may be broken during winding. In addition, the thin-width film may swell at the time of unfreezing, which may cause blocking etc. Therefore, the thin-width film is preferably unfrozen before winding.

### <4. Thin-Width Film and Wound Body>

Next, a thin-width film obtained by the cutting method described above is described. The thin-width film is a film obtained by cutting the adhesive film into a width of less than 1 mm. Therefore, like the adhesive film, the thin-width film satisfies the above conditions 1 and 2. Furthermore, the width is less than 1 mm. The width is preferably 0.8 mm or less, further preferably 0.6 mm or less, further preferably 0.5 mm or less, further preferably less than 0.5 mm. A lower limit value of the width is not particularly limited, but may be 0.3 mm or more, for example. Therefore, an example of a preferable range of the width is equal to or greater than 0.3 mm and less than 1 mm.

A length of the thin-width film is not particularly limited, and may be set as appropriate in accordance with the purpose of the thin-width film. The length of the thin-width film may be 50 cm to 5000 m, for example. This includes a case where thin-width films are connected together. FIG. 2 illustrates an example. FIG. 2 illustrates a laminated film 1 in which a thin-width film 10 is formed on a base material film 20.

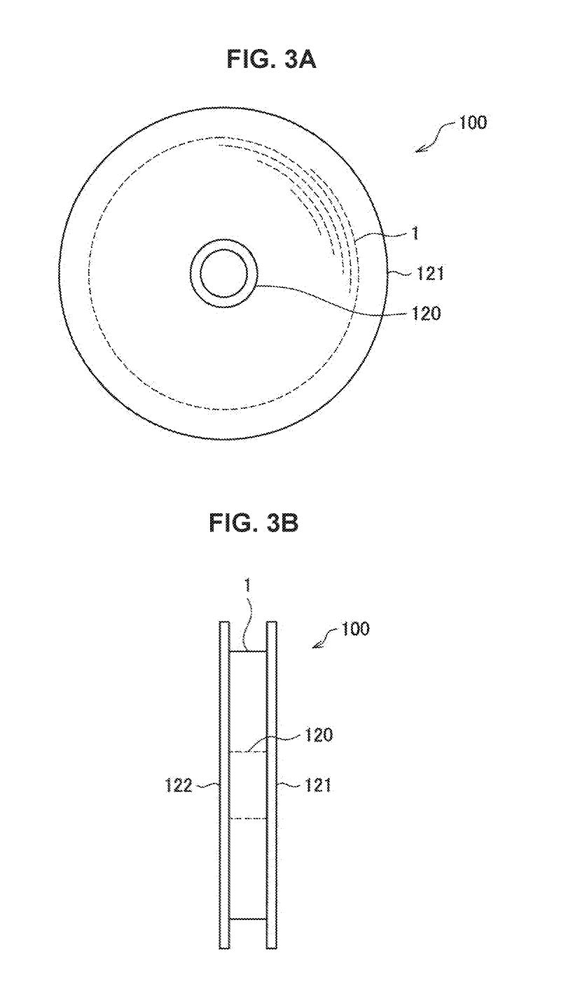

In addition, the thin-width film may be made into a wound body by being wound around an empty reel. The empty reel is fabricated by, for example, forming a flange on both sides in an axial direction of a core having a columnar or cylindrical shape. FIGS. 3A and 3B illustrate an example. A wound body 100 is fabricated by winding the laminated film 1 around an empty reel including a core 120 and flanges 121 and 122.

### EXAMPLES

### 1. Example 1

### (1-1. Fabrication of Adhesive Film)

Next, Example 1 of the present embodiment is described. In Example 1, a two-layer structure of an A layer and an N layer was used as an adhesive film. Therefore, an A layer composition and an N layer composition were prepared. Table 1 shows a basic composition of the A layer composition, and Table 2 shows a basic composition of the N layer composition.

TABLE 1

| | | Part |
|---|---|---|
| Product name | Manufacturer | by mass |
| YP-50 | NIPPON STEEL & SUMIKIN | 30 |
| | CHEMICAL CO., LTD. | |
| AEROSIL RY200 | NIPPON AEROSIL CO., LTD. | 7 |
| Micropearl AU | SEKISUI CHEMICAL CO., LTD | 10 |
| 5 μm ϕ | | |
| NK Ester DCP | Shin Nakamura Chemical Co., Ltd. | 5 |
| HEAA | KOHJIN Film & Chemicals Co., Ltd. | 3 |
| M-315 | TOAGOSEI CO., LTD. | 21 |
| PEROYL L | NOF CORPORATION | 2 |
| NYPER BMT | NOF CORPORATION | 5 |

TABLE 2

| | | Part |
|---|---|---|
| Product name | Manufacturer | by mass |
| FX-316 | NIPPON STEEL & SUMIKIN | 25 |
| | CHEMICAL CO., LTD. | |
| YP-50 | NIPPON STEEL & SUMIKIN | 14.5 |
| | CHEMICAL CO., LTD. | |
| AEROSIL RY200 | NIPPON AEROSIL CO., LTD. | 4 |
| TAKENATE L1600S | Mitsui Chemicals, Inc. | 20 |
| NK Ester DCP | Shin Nakamura Chemical Co., Ltd. | 19.5 |
| Karenz MT BD1 | SHOWA DENKO K.K. | 3 |
| PEROYL L | NOF CORPORATION | 1 |
| NYPER BMT | NOF CORPORATION | 5 |

In Example 1, additional components shown in Table 3 below were added to the A layer composition and the N layer composition. In other words, in Example 1 and Examples and Comparative Examples described below, a glass transition point and a tack value of the adhesive film were adjusted by adjusting parts by mass of the additional components. Note that the unit of values in Table 3 is part by mass.

TABLE 3

| | | | | | | | | | Compar- | Compar- | Compar- |
|---|---|---|---|---|---|---|---|---|---|---|---|
| | | | | | | | | | ative | ative | ative |
| | | Exam- | Exam- | Exam- | Exam- | Exam- | Exam- | Exam- | Exam- | Exam- | Exam- |
| | Manufacturer | ple 1 | ple 2 | ple 3 | ple 4 | ple 5 | ple 6 | ple 7 | ple 1 | ple 2 | ple 3 |
| YP745PMA | PTI JAPAN LTD. | 7.0 | 6.0 | 12.0 | 12.0 | 3.0 | 8.0 | 6.0 | 12.0 | 3.0 | 5.5 |
| SG600LB | Nagase ChemteX Corporation | 7.0 | 3.0 | 8.0 | 5.0 | 6.0 | 8.0 | 7.0 | 2.5 | 4.0 | 2.5 |
| RKB5515 | Resinous Kasei Co., Ltd. | 6.0 | 11.0 | 0.0 | 3.0 | 11.0 | 4.0 | 7.0 | 5.5 | 13.0 | 12.0 |

Then, a polyethylene terephthalate (PET) film with a width of 10 cm and a length of 80 cm was prepared as a base material film. Then, the A layer composition and the N layer composition were applied sequentially onto the base material film while the base material film was conveyed at a speed of 3.5 m/minute. Then, these applied layers were dried at 60° C.; thus, an adhesive film of a two-layer structure was formed on the base material film. A lower layer of the adhesive film is the A layer, and an upper layer is the N layer. The A layer had a thickness of 5 μm, and the N layer had a thickness of 15 μm.

### (1-2. Measurement of Glass Transition Point and Tack Value of Adhesive Film)

A glass transition point of the adhesive film was measured by a dynamic viscoelastometer RHEOVIBRON, A&D Company, Limited. Measurement conditions are as follows. Table 4 shows the measurement results.

Measurement temperature: −10 to −200° C.
Temperature rise rate: 3° C./min

### Frequency: 11 Hz

In addition, a tack value of the adhesive film was measured by a tack tester (PICMA Tack Tester, model: PICMA1, Toyo Seiki Seisaku-sho, Ltd.). Measurement conditions of the tack value are as follows. Table 4 shows the measurement results.

Measurement temperature: 25° C.

### Pressure: 4.9N

Contact time: 1 sec
Peel rate: 30 mm/min
Width of adhesive film: 1 cm

TABLE 4

| | | | | | | | | Comparative | Comparative | Comparative |
|---|---|---|---|---|---|---|---|---|---|---|
| | Example 1 | Example 2 | Example 3 | Example 4 | Example 5 | Example 6 | Example 7 | Example 1 | Example 2 | Example 3 |
| Tg(° C.) | 6.8 | 14.0 | 21.3 | 30.1 | −3.3 | 19 | 11.9 | 37.8 | 5.6 | 21.8 |
| TAC(N/cm) | 9.8 | 3.1 | 6.1 | 3.3 | 12.0 | 4.8 | 7.3 | 1.1 | 2.9 | 2.2 |

### (1-3. Cutting Process)

A cutting device was installed in a workroom cooled to −5° C. and subjected to dehumidification. Then, the adhesive film was cut using the cutting device. Here, a conveyance speed of the adhesive film to the cutting device was set to 10 m/min, and a cutting width was set to 0.6 mm. In addition, cutting was performed after the cutting blade and the adhesive film were cooled to −10° C. by liquid nitrogen.

### (1-4. Evaluation of Slitting Property)

In the above cutting process, slitting property was evaluated by the following evaluation criteria. Note that attachment of the adhesive film to the cutting blade was visually checked after cutting. Table 5 shows the evaluation results.

A: The adhesive film was able to be cut without attachment of the adhesive film to the cutting blade.
B: There was attachment of the adhesive film to the cutting blade, but the adhesive film was able to be cut. Thus, there was no practical problem.
C: The adhesive film was not able to be cut, or a practical problem occurred in a shape after the cutting.

### (1-5. Evaluation of Blocking Resistance)

After the temperature of the thin-width film was returned to room temperature, blocking resistance of the thin-width film was evaluated by the following method. First, flange parts were formed by winding a sticky tape at both ends in an axial direction of a cylindrical member with a diameter of 85 mm. The thin-width film was wound around an empty reel fabricated by the above process. Then, the wound body was subjected to a load of 50 g and held for six hours under an environment of 30° C. After that, the thin-width film was manually pulled out from the wound body. Then, it was checked whether peeling occurred between the thin-width film and the base material film during the pull-out. Occurrence of peeling means occurrence of blocking. Hence, blocking resistance was evaluated by the following evaluation criteria. Table 5 shows the evaluation results.

A: No peeling.
B: There was peeling of less than one round of the reel, i.e., peeling of a level causing no practical problem.
C: There was peeling of one round or more of the reel.

### (1-6. Evaluation of Electrical Characteristics)

An ITO glass substrate (thickness: 0.7 mm) and a flexible substrate (FPC) were prepared. Here, on the flexible substrate were arranged tin wires with a width of 17.5 μm and an inter-wire distance of 17.5 μm (i.e., a pitch of 35 μm, L/S ratio=1). Then, the ITO glass substrate, the thin-width film, and the flexible substrate were stacked sequentially on a stage, and a buffer material was placed on them. Then, these were crimped using a crimping tool. Crimping conditions were as follows. A connection structure was fabricated by the above process. Table 5 shows the evaluation results.

Tool width: 1.2 mm
Crimping temperature: 150° C.
Stage temperature: 80° C.
Buffer material: Teflon (registered trademark) (thickness: 150 μm)

Then, connection resistance of the connection structure was measured using a digital multi-meter (a digital multi-meter 7561, Yokogawa Electric Corporation). Measurement was performed for 16 chs, and an arithmetic mean value of measurement values of the chs was taken as the connection resistance. Then, electrical characteristics were evaluated by the following evaluation criteria. Table 5 shows the evaluation results.

A: Connection resistance was 1.5Ω or less.
B: Connection resistance was 2.5Ω or less, i.e., of a level inferior to A but not causing a practical problem.
C: Connection resistance was greater than 2.5Ω.

### (1-7. Peel Strength)

A 90° peel test of the above connection structure was performed using a tensile tester (product name: TENSILON, A&D Company, Limited). Recording speed was set to 50 mm/min, and test speed was set to 300 mm/min. Then, a maximum value was read from a measurement chart. Then, peel strength was evaluated by the following evaluation criteria. Table 5 shows the evaluation results.

OK: 5N/cm or more
NG: less than 5N/cm

TABLE 5

| | | | | | | | | Comparative | Comparative | Comparative |
|---|---|---|---|---|---|---|---|---|---|---|
| | Example 1 | Example 2 | Example 3 | Example 4 | Example 5 | Example 6 | Example 7 | Example 1 | Example 2 | Example 3 |
| slitting property | A | A | A | A | B | A | A | A | A* | A* |
| blocking resistance | A | A | A | A | B | A | A | A | B | A |
| electrical | A | A | A | A | A | A | A | B | A | A |
| characteristics | | | | | | | | | | |
| peel strength | OK | OK | OK | OK | OK | OK | OK | NG | OK | OK |

*In Comparative Examples 2 and 3, when cutting temperature was −40° C., a practical problem occurred in a shape after the cutting.

### 2. Examples 2 to 7 and Comparative Examples 1 to 3

Processes similar to those in Example 1 were performed, except that the composition of additional components was changed to compositions shown in Table 3.

### 3. Consideration

Examples 1 to 7 correspond respectively to points P1 to P7 in FIG. 1, and Comparative Examples 1 to 3 correspond respectively to points P8 to P10 in FIG. 1. According to distribution of these points, it was found that in order to improve slitting property, blocking resistance, electrical characteristics, and peel strength of the thin-width film, a glass transition point and a tack value of the adhesive film at least need to be present in a region below the straight line L1. Furthermore, according to Comparative Examples 1 to 3 and Example 2, it was also found that the tack value needs to be 3N/cm or more. In addition, Example 5 was slightly inferior to Examples 1 to 4 in slitting property and blocking resistance. This is estimated to be because the tack value of Example 5 is higher than those of Examples 1 to 4. Therefore, it was also found that the tack value is preferably 10N/cm or less. In addition, since the results of Examples 1, 2, 3, 4, 6, and 7 were the most preferable, it was found that characteristics of the adhesive film are highest in the region A surrounded by the points P1 to P4 corresponding to Examples 1 to 4. Note that the results of Comparative Examples 2 and 3 were favorable, but when cutting temperature of Comparative Examples 2 and 3 was set to −40° C., a practical problem occurred in a shape of the adhesive film after the cutting.

In addition, although tack values of Examples 1 to 7 are relatively high, the adhesive film was able to be cut without a problem in slitting property by performing cutting after cooling the adhesive film etc. to −10° C. Here, almost similar results were obtained when the adhesive film of Example 1 was cut at −40° C. and 10° C. However, when the adhesive film of Example 1 was cut at −45° C., the adhesive film partly exhibited a break at the time of cutting. On the other hand, the adhesive film of Example 1 was tried to be cut at 15° C., but the adhesive film was not able to be cut. Therefore, it was also found that the adhesive film can be cut with high precision by cutting the adhesive film at −40 to 10° C.

The preferred embodiment(s) of the present invention has/have been described above with reference to the accompanying drawings, whilst the present invention is not limited to the above examples. A person skilled in the art may find various alterations and modifications within the scope of the appended claims, and it should be understood that they will naturally come under the technical scope of the present invention.

### REFERENCE SIGNS LIST

1 laminated film
10 adhesive film (thin-width film)
20 base material film
100 wound body
120 core
121, 122 flange

1. A method for cutting an adhesive film, the method comprising
cutting, under a temperature environment of −40 to 10° C., an adhesive film that satisfies a condition of the following formula (1) and whose tack value per unit length under room temperature is 3N/cm or more:
y=−0.27x+11.4 (1),
where x is a glass transition point (° C.) of the adhesive film, and y is a tack value per unit length (N/cm) under room temperature of the adhesive film.

2. The method for cutting an adhesive film according to claim 1, wherein the tack value of the adhesive film is 10N/cm or less.

3. The method for cutting an adhesive film according to claim 1, wherein the adhesive film is cut into a width of less than 1 mm.

4. The method for cutting an adhesive film according to claim 1, wherein the adhesive film is cut while a cutting blade that cuts the adhesive film is cooled.

5. The method for cutting an adhesive film according to claim 1, wherein the adhesive film is cut while ultrasonic vibration is applied to a cutting blade that cuts the adhesive film.

6. An adhesive film that satisfies a condition of the following formula (1) and has a tack value under room temperature of 3N/cm or more and a width of less than 1 mm:
y=−0.27x+11.4 (1),
where x is a glass transition point (° C.) of the adhesive film, and y is a tack value (N/cm) of the adhesive film.

7. The adhesive film according to claim 6, wherein the adhesive film contains conductive particles.

8. A wound body comprising
the adhesive film according to claim 6.
